(19) United States
(12) Patent Application Publication
(10) Pub. No.: US 2012/0248896 A1
(43) Pub. Date: Oct. 4, 2012

(54) FIELD DEVICE

(75) Inventor: Kouji Okuda, Tokyo (JP)

(73) Assignee: YAMATAKE CORPORATION, Tokyo (JP)

(21) Appl. No.: 13/418,823

(22) Filed: Mar. 13, 2012

(30) Foreign Application Priority Data
Mar. 30, 2011 (JP) 2011-075004

(51) Int. Cl. H01H 47/00

(52) U.S. Cl. 307/131

(57) ABSTRACT

A switch is provided in a supply line for an operating power supply from an operating power supply generating circuit to a main circuit, An electric current detecting circuit and a comparison evaluating circuit are provided as a controlling circuit portion for controlling the ON/OFF state of the switch. The electric current detecting circuit inputs a voltage in accordance with the value of an electric current supplied from an higher-level system, and inverts and amplifies the voltage to produce an output voltage. The comparison evaluating circuit inputs the output voltage from the electric current detecting circuit, compares the output voltage to a reference voltage, and turns the switch ON if the output voltage is higher than the reference voltage. The reference voltage is set in advance in accordance with a lower limit electric current value for the electric current that must be supplied for the main circuit to operate properly.

### CROSS REFERENCE TO RELATED APPLICATIONS

The present application claims priority under 35 U.S.C. §119 to Japanese Patent Application No. 2011-075004, filed Mar. 30, 2011, which is incorporated herein by reference.

### FIELD OF TECHNOLOGY

The present invention relates to a field device, such as a positioner, that operates by generating its own operating power supply from an electric current that is supplied through a pair of electric wires from a higher-level system.

### BACKGROUND

Conventionally positioners, which are field devices that control the degrees of opening of regulator valves, are designed so as to operate with an electric current between 4 and 20 mA sent through a pair of electric wires from a higher-level system. For example, if a current of 4 mA is sent from the higher-level system, the opening of the regulator valve is set to 0%, and if a current of 20 mA is sent, then the opening of the regulator valve is set to 100%.

In this case, the electric current that is supplied from the higher-level system varies in the range of 4 mA through 20 mA, and thus the internal circuitry within the positioner produces its own operating power supply from an electric current of no less than 4 mA, which can always be secured as an electric current value that is supplied from the higher-level system (See, for example, Japanese Unexamined Patent Application Publication 2004-151941).

FIG. 8 is illustrates the critical components in a conventional positioner. This positioner 100 receives a supply of an electric current I through a pair of electric wires L1 and the L2 from the higher-level system 200 and generates its own operating power supply from the electric current I that is supplied, and, on the other hand, also controls the degree of opening of a regulator valve, not shown, in accordance with the value of the supplied electric current I.

The positioner 100 is provided with a main circuit 2 that includes a CPU (calculation processing portion) 1, an operating power supply generating circuit 3 that includes a zener diode D1, and the resistor R1. The operating power supply generating circuit 3 and the resistor R1 are connected in series between the terminals T1 and T2 through which the current I from the higher-level system 200 is inputted/outputted, and the connecting point between the operating power supply generating circuit 3 and the resistor R1 is grounded.

In this positioner 100, the operating power supply generating circuit 3 generates a constant voltage V1 from the electric current from the higher-level system 200, and supplies that generated constant voltage V1 to the main circuit 2 as an operating power supply V2.

Note that, as illustrated in FIG. 9, the constant voltage V1 that is generated by the operating power supply generating circuit 3 is supplied to a main power supply circuit 4 as the operating power supply V2, and, in this main power supply circuit 4, is set to a voltage V3 that is appropriate for the main circuit 2, in a system wherein this voltage V3 is supplied to the main circuit 2 as the operating power supply.

However, in the circuit structure illustrated in FIG. 8 and FIG. 9, even though the scope of the electric current of the supply electric current I wherein proper operation is possible is defined as a specification of the positioner 100, and even though there are no problems as long as the supplied electric current I ramps up quickly to the electric current range wherein proper operation is possible at the time of for example, startup of the supply of power from the higher-level system 200 (referencing Curve I shown in FIG. 10), if the supplied electric current I changes slowly (referencing Curve II shown in FIG. 10), there is the risk that the main circuit 2 that includes the CPU 1 will start up with the voltage generated by the operating power supply generating circuit 3 being inadequate, producing an erratic operating state, which may cause malfunctions such as a valve being opened unintentionally. Moreover, there is also the risk of a similar malfunction occurring when there is a drop in the supplied electric current I, that is, when it falls below the electric current wherein proper operation is possible, even after a normal startup of the main circuit 2 that includes the CPU 1, in a state wherein the power supply has already started up.

Note that Japanese Unexamined Patent Application Publication H03-212799 (Japanese Patent Number 2753592) (“JP '799”) shows a double-wire instrument that receives the supply of power (a voltage) through a two-wire transmission line, measures a physical quantity, such as a flow rate, and transmits an electric current signal in accordance with the measured value. In this double-wire instrument, drops in the terminal voltage arc monitored, and if a drop in the terminal voltage is detected, the microprocessor is initialized and a warning is sent. However, even though there has been an attempt to solve the problem with the positioner, set forth above, through the application of the technology disclosed in this JP '799, given the following facts, the problem cannot he solved easily.

The double-wire instrument described in JP '799 is a voltage input-type instrument, but the positioner is an electric current input-type device, and thus the mode of operation is different.

While a case wherein a fault occurs, such as a drop in the power supply voltage from a state wherein the double-wire instrument is operating normally, can be handled by the technology described in JP '799, it is not possible to detect whether or not there have been proper operations.

The present invention is to solve such problems, and the object thereof is to provide a field device able to operate by generating its own operating power supply from an electric current that is supplied through a pair of electric wires from a higher-level system.

### SUMMARY

In order to achieve the object set forth above, the field device according to examples of the present invention includes an operating power supply generating circuit for generating an operating power supply from an electric current that is supplied through a pair of electric wires from a higher-level system; a main circuit, which includes a calculation processing portion, which operates by receiving a supply of an operating power supply from the operating power supply generating circuit; a switch that is provided in the supply line for the operating power supply to the main circuit; an electric current detecting circuit for detecting, as a present electric current value, a value of an electric current that is supplied through the pair of electric wires; and a comparison evaluating circuit for comparing a value in accordance with the present electric current value that is detected by the electric current detecting circuit and a comparison evaluation value that is set in advance as a value in accordance with a lower limit electric current value for the electric current that must be supplied for the main circuit to operate properly, to close the switch when the value in accordance with the present electric current value is higher than the comparison evaluation value, and to open the switch if the value in accordance with the present electric current value is lower than the comparison evaluation value.

In the examples of the present invention, the value of the electric current that is provided through the pair of electric wires is detected as the present electric current value, a value in accordance with the present electric current value that has been detected is compared to a comparison evaluation value that has been set in advance (a value in accordance with a lower electric current value for the electric current supply that is required for proper operation of the main circuit), and a switch is closed if the value in accordance with the present electric current value is higher than the comparison evaluation value, to supply the operating power supply from the operating power supply generating circuit to the main circuit. Moreover, if the value in accordance with the present electric current value is lower than the comparison evaluation value, then the switch is opened, to cut off the operating power supply to the main circuit from the operating power supply generating circuit.

Note that in the examples of the present invention, the value in accordance with the present electric current value and the value in accordance with the lower limit electric current value may be the electric current values themselves, or may be values that are converted into a voltage values.

In the examples of the present invention, a switch is provided in the supply line to the main circuit of the operating power supply from the operating power supply generating circuit, the value of the electric current supplied through the pair of electric wires is detected as the present electric current value, a value in accordance with the lower limit electric current value of the electric current that must be supplied for the main circuit to operate properly is defined as a comparison evaluation value, and a switch is closed if the value in accordance with the present electric current value is higher than the comparison evaluation value, but the switch is opened if the value in accordance with the present electric current value is lower than the comparison evaluation value, and thus the operating power supply is not be supplied to the main circuit from the operating power supply generating circuit if the present electric current value is less than the lower limit electric current value required for the main circuit to operate properly, making it possible to prevent the occurrence of problems due to the main circuit operating in an unstable state.

### BRIEF DESCRIPTION OF THE DRAWINGS

FIG. 1 is a structural diagram of the critical portions in an example of a field device according to the present invention.

FIG. 2 is a diagram illustrating a circuit example of an electric current detecting circuit used in the field device (positioner) of FIG. 1.

FIG. 3 is a diagram illustrating a circuit example of a comparison evaluating circuit used in this field device (positioner).

FIG. 4 is a structural diagram of the critical portions in another example of a field device.

FIG. 5 is a diagram illustrating another circuit example of a comparison evaluating circuit.

FIG. 6 is a diagram illustrating a circuit example of a comparison evaluating circuit with hysteresis.

FIG. 7 is a diagram illustrating another circuit example of a comparison evaluating circuit with hysteresis.

FIG. 8 is a diagram illustrating the critical components in a conventional positioner,

FIG. 9 is a diagram illustrating the critical components in a conventional positioner, where the main unit power supply circuit is used.

FIG. 10 is a diagram illustrating an example of varying the electric current supply I at the time of starting up the power supply.

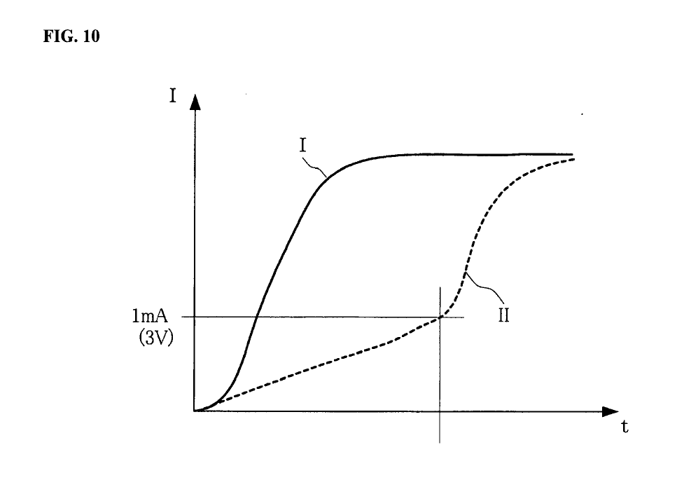

### DETAILED DESCRIPTION

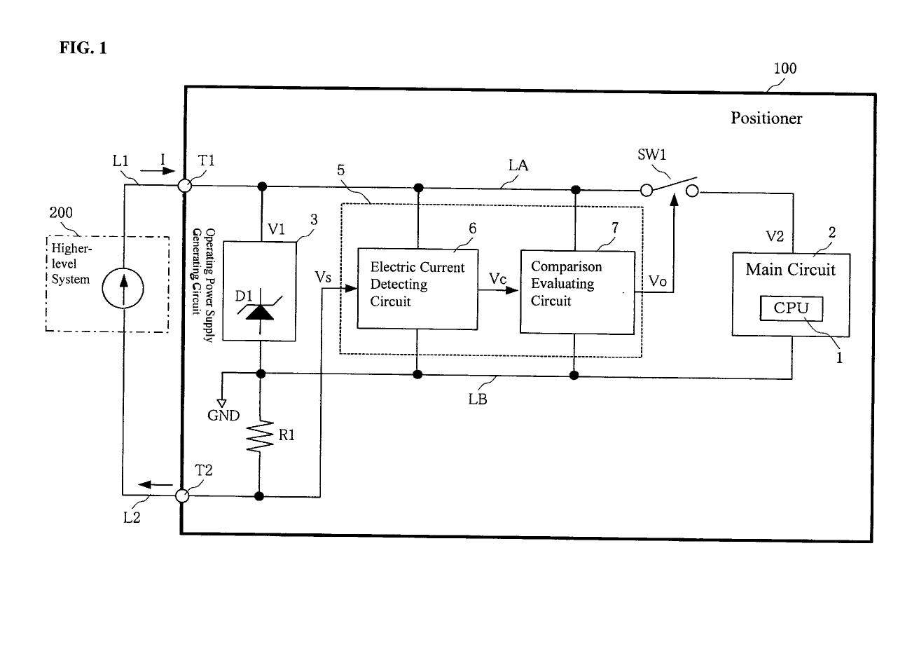

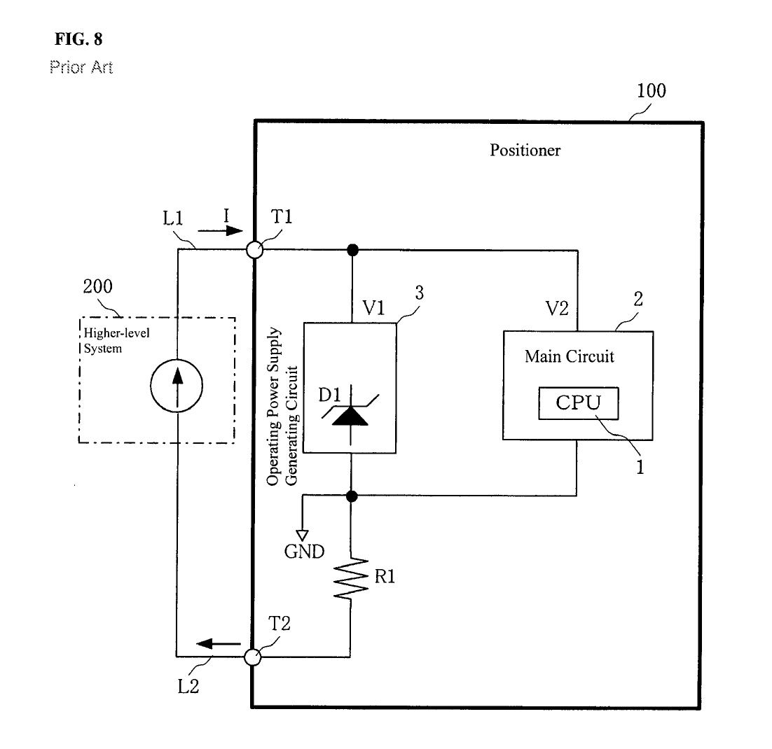

Examples of the present invention are explained below in detail, based on the drawings. FIG. 1 is a structural diagram of the critical portions in an example of a field device according to the present invention. In this figure, codes that are the same as those in FIG. 8 indicate identical or equivalent structural elements as the structural elements explained in reference to FIG. 8, and explanations thereof are omitted.

In the present form of embodiment the positioner 100 is provided with a switch SW1 in the supply line LA for the operating power supply V2 from the operating power supply generating circuit 3 to the main circuit 2, and provided with an electric current detecting circuit 6 and a comparison evaluating circuit 7 as a controlling circuit portion 5 for controlling the ON/OFF state (the open/closed state) of the switch SW1.

The electric current detecting portion 6 and the comparison evaluating circuit 7 are connected in parallel between a ground line LB and the line on the upstream side of the switch SW1 in the supply line LA for the operating power supply V2 from the operating power supply generating circuit 3 to the main circuit 2. The electric current detecting circuit 6 and the comparison evaluating circuit 7 operate on an electric current that is substantially lower than the electric current that must be consumed in the main circuit 2 (for example, no less than 1 mA).

The electric current detecting circuit 6 inputs a voltage Vs that is produced where the electric current I flows out of the resistor R1, that is, inputs a voltage Vs in accordance with the value of the electric current I that is supplied through the pair of electric wires L1 and L2 from the higher-level system 200, and inverts and amplifies this voltage Vs to produce an output voltage Vc. This output voltage Vc indicates the present electric current value of the supplied electric current I.

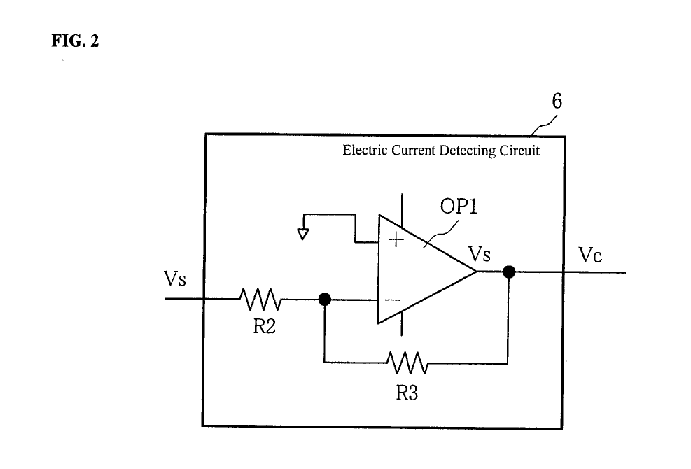

An example circuit for the electric current detecting circuit 6 is illustrated in FIG. 2. This electric current detecting circuit 6 is structured from an op amp OP1, a resistor R2, and a resistor R3, where one end of the resistor R2 is connected to the inverting input terminal of the op amp OP1, the resistor R3 is connected between the inverting input terminal and the output terminal of the op amp OP1, and the non-inverting input terminal of the op amp OP1 is grounded. As a result, the electric current detecting circuit 6 operates as an inverting amplifier.

In the circuit example for the electric current detecting circuit 6, the voltage Vs is inputted into the non-inverting input terminal of the op amp OP1 through the resistor R2, to obtain the voltage Vc, wherein the voltage Vs has been inverted and amplified, from the output terminal of the op amp ON. Note that in this case the voltage Vs is lower than the ground voltage, and thus it is inverted by the electric current detecting circuit 6. Moreover, because the voltage Vs is an extremely small voltage, preferably the amplification in the electric current detecting circuit 6 provides stable detection.

The comparison evaluating circuit 7 inputs the output voltage Vc from the electric current detecting circuit 6, compares the output voltage Vc to a reference voltage (a comparison evaluation voltage) Vd, and switches the state of the switch SW1 ON/OFF depending on the comparison result. The reference voltage Vd in the comparison evaluating circuit 7 is set in advance as a value in accordance with the lower limit electric current value for the electric current I that must be supplied for the main circuit 2 to function properly. In this example, the lower limit electric current value is, for example, no less than 2 mA.

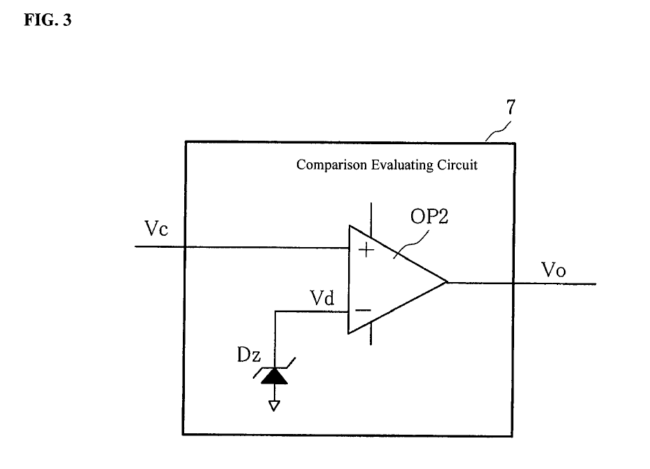

A circuit example for the comparison evaluating circuit 7 is illustrated in FIG. 3. This comparison evaluating circuit 7 is structured from an op amp OP2 and a zener diode Dz, where the reference voltage Vd that is produced by the zener diode Dz is applied to the inverting input terminal of the op amp OP2.

In the circuit example of the comparison evaluating circuit 7, the output voltage Vc from the electric current detecting circuit 6 is applied to the non-inverting input terminal of the op amp OP2, and compared to the reference voltage Vd that is applied to the inverting input terminal of the op amp OP2. If the output voltage Vc is greater than the reference voltage Vd, then the op amp OP2 inverts the output voltage Vo thereof from the “L” level to the “H” level, to switch the switch SW1 ON. Moreover, if the output voltage Vc is lower than the reference voltage Vd, then the output voltage Vo thereof inverts from the “H” level to the “L” level, to switch the switch SW1 OFF.

When Starting Up the Power Supply Supplied from the Higher-Level System

Here it is assumed that the power supply that is supplied from the higher-level system 200 is starting up, and the electric current I that is supplied changes gradually. In this case, the electric current detecting circuit 6 and the comparison evaluating circuit 7 begin to operate when the voltage V1 from the operating power supply generating circuit 3 rises above the operating voltage thereof. The switch SW1 is turned OFF.

The electric current detecting circuit 6, upon the commencement of operation, detects the voltage Vs that is produced at the side of the resistor R1 from which the electric current I flows, and inverts and amplifies this voltage Vs to be an output voltage Vc, which is sent to the comparison evaluating circuit 7.

The comparison evaluating circuit 7 compares the voltage Vc that is outputted from the electric current detecting circuit 6 to the reference voltage Vd, and, if the output voltage Vc is in excess of the reference voltage Vd, inverts the output voltage Vo thereof from the “L” level to the “H” level, to turn the switch SW1 ON. Doing so begins the supply of the voltage V1 of the operating power supply generating circuit 3 to the main circuit 2 as the operating power supply V2.

In this case, the reference voltage Vd is a value in accordance with the lower limit electric current value for the electric current I that must be supplied in order for the main circuit 2 to operate properly, and thus the switch SW1 is turned ON when in a state wherein the supplied electric current I is greater than the electric current value required in order for the main circuit 2 to operate properly, that is, in a state wherein the operating power supply V2 that is generated by the operating power supply generating circuit 3 is no less than the voltage value required for the main circuit 2 to operate properly.

As a result, the main circuit 2, which includes the CPU 1, does not start up with a voltage that is insufficient, and thus there is no risk of malfunction, such as a regulator valve opening unintentionally, because of an erratic start-up state.

When the Electric Current That is Supplied Sags When the Power Supply Has Been Started Up

If after the main circuit 2 that includes the CPU 1 has been started up properly, the electric current I that is supplied sags to fall below the electric current wherein proper operation is possible, the comparison evaluating circuit 7 inverts the output voltage Vo thereof from the “H” level to the “L” level, to switch the switch SW1 OFF. Doing so cuts off the supply to the main circuit 2 of the operating power supply V2 from the operating power supply generating circuit 3, thus preventing the main circuit 2, which includes the CPU 1, from operating in an unstable state, preventing the occurrence of malfunctions.

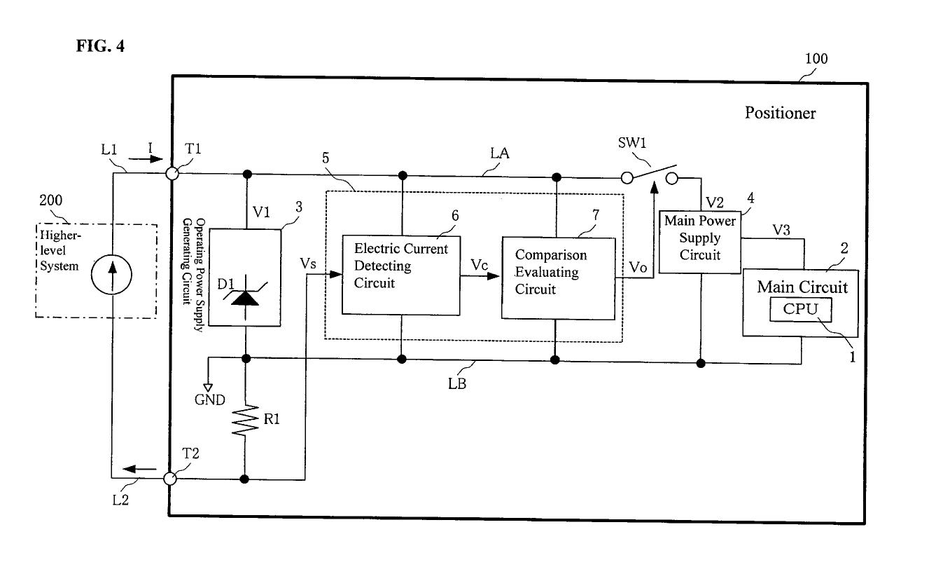

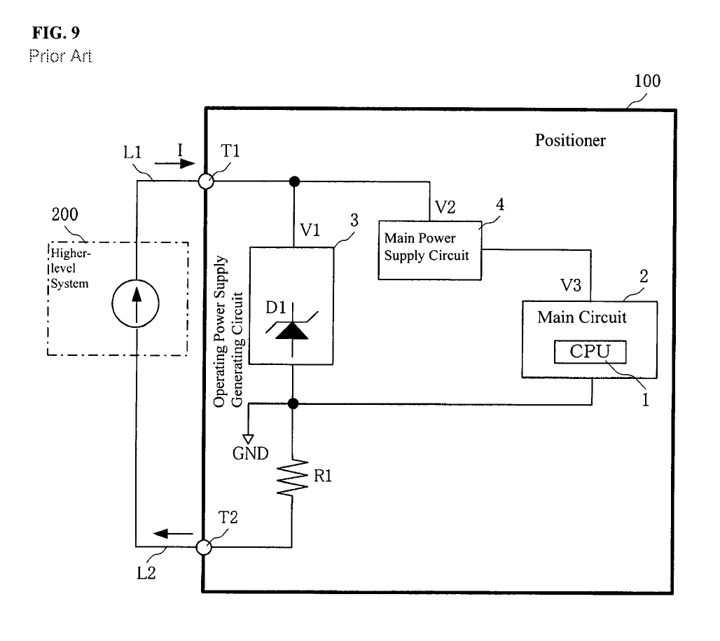

Note that while FIG. 1 shows an example of an application to the system illustrated in FIG. 8, it can also be applied similarly to the system illustrated in FIG. 9. FIG. 4 shows an example of an application to the system illustrated in FIG. 9, When applied to the system illustrated in FIG. 9, the switch SW1 is provided in a line upstream from the main power supply circuit 4 in the supply line LA of the operating power supply V2 to the main circuit 2 from the operating power supply generating circuit 3.

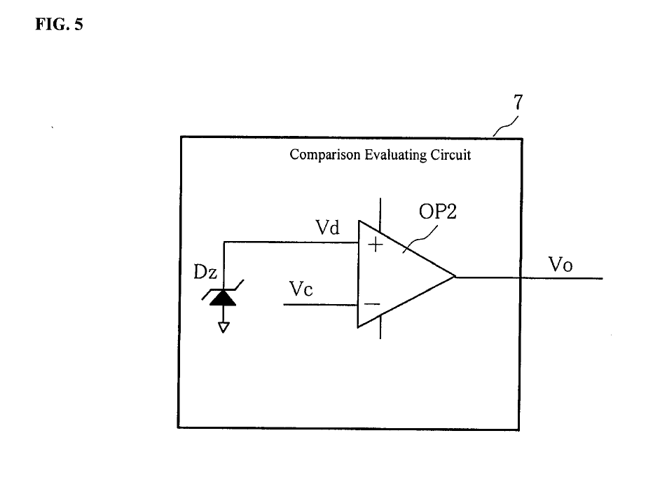

Moreover, in the comparison evaluating circuit 7 illustrated in FIG. 3, a reference voltage Vz that is generated by a zener diode Dz is applied to the inverting input terminal of an op amp OP2, and the output voltage Vc from the electric current detecting circuit 6 is applied to the non-inverting input terminal of the op amp OP2, but, instead, as illustrated in FIG. 5, the reference voltage Vz that is generated by the zener diode Dz may be applied to the non-inverting input terminal of the op amp OP2, and the output voltage Vc from the electric current detecting circuit 6 may be applied to the inverting input terminal of the op amp OP2.

In the example circuit for the comparison evaluating circuit 7 illustrated in FIG. 5, if the output voltage Vc is higher than the reference voltage Vd, then the op amp OP2 inverts the output voltage Vo thereof from the “H” level to the “L” level, to switch the switch SW1 ON. Moreover, if the output voltage Vc is lower than the reference voltage Vd, then the output voltage Vo thereof is inverted from the “L” level to the “H” level, to switch the switch SW1 OFF.

Moreover, while in the comparison evaluating circuit 7 in FIG. 1 the output voltage Vc from the electric current detecting circuit 6 was compared to a single reference voltage (comparison evaluation value) Vz, instead a first reference voltage (first comparison evaluation value) VhI and a second reference voltage (second comparison evaluation value) Vlo, which is lower, by a specific value, than the first reference voltage VhI may be provided as reference voltages, where the switch SW1 may be switched ON if the output voltage Vc from the electric current detecting circuit 6 rises to be higher than the first reference voltage VhI, and the switch SW1 may be turned OFF if the output voltage Vc from the electric current detecting circuit 6 falls to be lower than the second reference voltage Vlo. Doing this provides hysteresis in the comparison evaluation value, making it possible to prevent instability in the ON/OFF of the switch SW1.

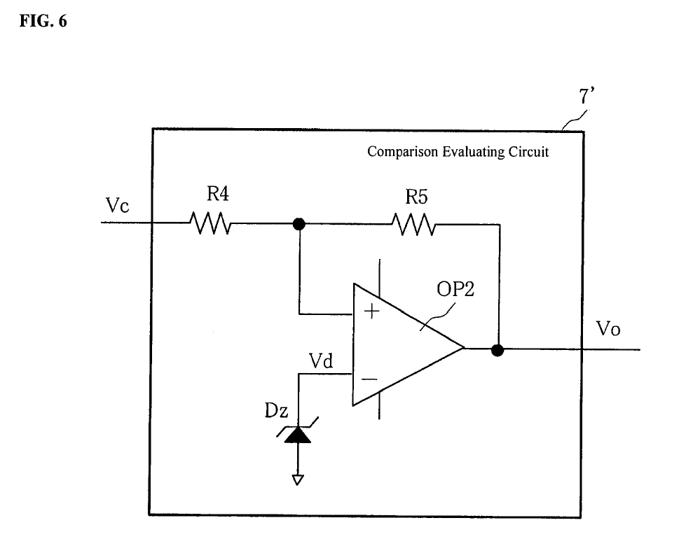

FIG. 6 shows a specific example of a comparison evaluating circuit 7′ for a case wherein hysteresis is provided in the comparison evaluation value, In this comparison evaluating circuit 7′, one end of a resistance R4 is connected to the non-inverting input terminal of an op amp OP2, a resistance R5 is connected between the non-inverting input terminal and the output terminal of the op amp OP2, and a reference voltage Vz that is produced by a zener diode Dz is applied to the inverting input terminal of the op amp OP2.

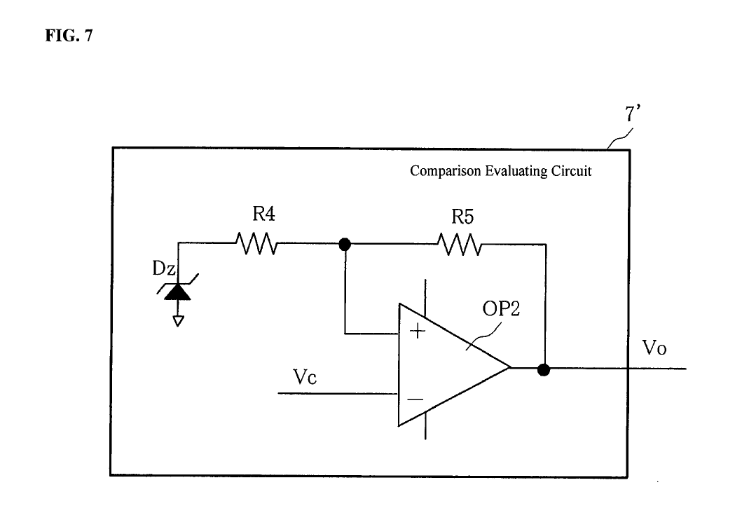

In this specific example of a comparison evaluating circuit 7′, the output voltage Vc from the electric current detecting circuit 6 is monitored, and compared to the comparison voltages VhI and Vlo based on the reference voltage Vz, and if rising from 0V, then if the comparison voltage VhI is exceeded, the output voltage Vlo is inverted from the “L” level to the “H” level. Moreover, if falling from a high voltage, the output voltage Vo is inverted from the “H” level to the “L” level when below the comparison voltage Vlo. FIG. 7 shows a specific example of a comparison evaluating circuit 7′ operating in the inverse from the operation illustrated in FIG. 6.

The field device according to the present invention can be used in a variety of fields, such as process control, as, for example, a positioner for controlling the opening of a regulator valve.

1. A field device comprising:
an operating power supply generating circuit generating an operating power supply from an electric current that is supplied through a pair of electric wires from a higher-level system;
a main circuit, which includes a calculation processing portion, which operates by receiving a supply of an operating power supply from the operating power supply generating circuit;
a switch provided in the supply line for the operating power supply to the main circuit;
an electric current detecting circuit detecting, as a present electric current value, a value of an electric current that is supplied through the pair of electric wires; and
a comparison evaluating circuit comparing a value in accordance with the present electric current value that is detected by the electric current detecting circuit and a comparison evaluation value that is set in advance as a value in accordance with a lower limit electric current value for the electric current that must be supplied for the main circuit to operate properly, to close the switch when the value in accordance with the present electric current value is higher than the comparison evaluation value, and to open the switch if the value in accordance with the present electric current value is lower than the comparison evaluation value.

2. The field device as set forth in claim 1, wherein:
the comparison evaluating circuit has a first comparison evaluation value and a second. comparison evaluation value, which is set so as to be a specific value lower than the first comparison evaluation value, as comparison evaluation values, to close the switch when the value in accordance with the present electric current value rises above the first comparison evaluation value, and to open the switch when the value in accordance with the present electric current value falls below the second comparison evaluation value.

3. The field device as set forth in claim 1, wherein:
the calculation processing portion of the main circuit controls a degree of opening of a regulator valve in accordance with a value of an electric current that is supplied through the pair of electric wires.
